(19) United States
(12) Patent Application Publication
(10) Pub. No.: US 2020/0160038 A1
(43) Pub. Date: May 21, 2020

(54) Electronic Device, and Visual Recognition System and Method Thereof

(71) Applicant: Huaian Imaging Device Manufacturer Corporation, Huaian (CN)

(72) Inventors: Jinfeng GONG, Huaian (CN); Yonggang Wang, Huaian (CN); Jianguang Chang, Huaian (CN)

(21) Appl. No.: 16/110,446

(22) Filed: Aug. 23, 2018

(30) Foreign Application Priority Data
Jan. 10, 2018 (CN) 201810022860.3

(51) Int. Cl. G06K 9/00; G06F 3/0346; G06F 3/01; G06F 3/0354

(52) U.S. Cl. CPC G06K 9/00288; G06F 3/03545; G06F 3/017; G06F 3/0346

(57) ABSTRACT

A visual recognition system and a method of operation are disclosed. The visual recognition system includes: a distance sensor, configured to detect an object close to the system; and a visual recognition module, configured to compare, when the distance sensor detects the object is close, whether the object matches the preset visual recognition mode. By using a low power distance sensor in a visual recognition system, the system's power consumption can be reduced, thereby prolonging the battery lifetime of the system.

### CROSS REFERENCES TO RELATED APPLICATIONS

This application claims the benefit of priority to Chinese Patent Application No. CN201810022860.3, entitled “Electronic Device, and Visual Recognition System and Method thereof”, filed with SIPO on Jan. 11, 2018, the contents of which are incorporated herein by reference in its entirety.

### TECHNICAL FIELD

The present disclosure relates to the technical field of electronic devices, and in particular, to a visual recognition system and method thereof.

### BACKGROUND

The existing mobile devices may perform identity recognition and unlocking by adopting different inputs such as passwords, fingerprints, and two-dimensional (2D) face recognitions. Recently, three-dimensional (3D) face recognitions have begun to appear. Typical 3D facial recognition methods include binocular recognition, structured light recognition, and flight time recognition.

However, in order to ensure good recognition, fairly complex algorithms are usually needed to implement complex 3D facial recognitions. When implementing on a mobile device, these complex algorithms all have the issues of high power consumption and incapability of running in the background all the time. The problem to be solved by the present disclosure is to reduce high device power consumption for running complex 3D facial recognition algorithms.

### SUMMARY

The present disclosure provides a visual recognition system, comprising: a distance sensor, configured to detect an object close to the system; and a visual recognition module, configured to compare if the object matches a preset visual recognition mode.

Optionally, the visual recognition mode comprises an unlocking recognition mode to unlock the system from a locked state, when the visual recognition module compares that the object matches the preset visual recognition mode.

Optionally, when a triggering condition is satisfied, the distance sensor starts, wherein the triggering condition comprises turning on a screen of the system or picking up the system.

Optionally, when the system is picked up, the screen of the system is turned on; or, when a power button of the system is pressed down, the screen of the system is turned on.

Optionally, the visual recognition system further comprises: a sensing module, configured to sense whether the system is picked up.

Optionally, the sensing module comprises at least one of an acceleration sensor, a gravity sensor, and a gyroscope.

Optionally, the unlocking recognition mode comprises facial recognition unlocking and/or gesture recognition unlocking.

Optionally, the distance sensor is an infrared sensor, an optical visible light sensor, or an ultrasonic distance sensor.

The present disclosure further provides an electronic device comprising the foregoing visual recognition system.

Optionally, the electronic device is a mobile terminal, a tablet computer, or an electronic book.

Moreover, the present disclosure further provides a visual recognition method, comprising:

detecting, by using a distance sensor, an object close to the electronic device; and

comparing, when the distance sensor detects that the object, whether the object matches with a preset visual recognition mode.

Optionally, when the electronic device is in a locked state, the visual recognition mode comprises an unlocking recognition mode; wherein the visual recognition method further comprises: unlocking the electronic device when it is detected that the object matches the preset visual recognition mode.

Optionally, when a triggering condition to the distance sensor is satisfied, the distance sensor starts, and wherein the triggering condition comprises turning on a screen of the electronic device or picking up the electronic device.

Optionally, the screen is turned on if the electronic device is picked up or a power button of the electronic device is pressed down.

Optionally, the visual recognition method further comprises: sensing, by using a sensing module, if the electronic device is picked up.

### BRIEF DESCRIPTION OF THE DRAWINGS

FIG. 1 is a schematic diagram of a visual recognition system according to an embodiment of the present disclosure.

FIG. 2 is a schematic diagram of a visual recognition system with an unlocking module according to another embodiment of the present disclosure.

FIG. 3 is a schematic diagram of a visual recognition system according to another embodiment of the present disclosure.

### DETAILED DESCRIPTION OF THE PREFERRED EMBODIMENTS

The foregoing objectives, features, and advantages of the present disclosure will become more apparent from the following detailed description of specific embodiments of the disclosure in conjunction with the accompanying drawings. In the detailed description of the embodiments of the present disclosure, for convenience of description, the schematic diagram will be partially enlarged not according to an ordinary ratio, and the schematic diagram is only an example, which should not limit the protection scope of the present disclosure. In addition, three-dimensional space dimensions of length, width, and depth should be comprised in actual production.

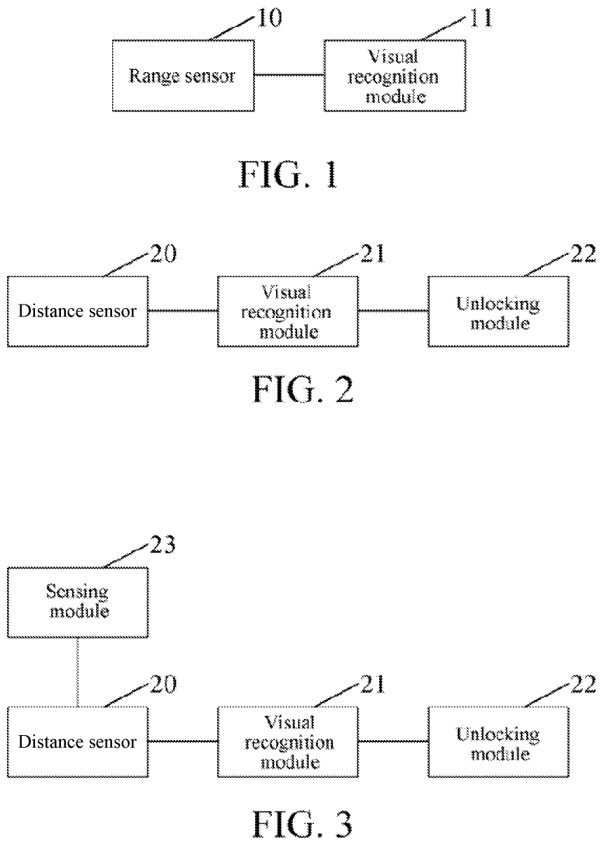

FIG. 1 is a schematic diagram of a visual recognition system according to an embodiment of the present disclosure. As shown in the figure, the system comprises a distance sensor 10 and a visual recognition module 11. The distance sensor 10 is configured to detect an object close to the system; and the visual recognition module 11 is configured to compare, when the distance sensor 10 detects that an object is close to system, whether the object matches with a preset visual recognition mode. The visual recognition mode may be, for example, human face (face) recognition, gesture recognition, etc. When the visual recognition module 11 compares that the object matches with the preset visual recognition mode, the system performs a number of designed actions, including: implementing a visual recognition function by adopting a image processing algorithm.

According to the embodiment, a distance sensor with low power consumption is used to detect an object within an appropriate distance, and when it is detected that an object is close to the system and it is necessary to perform visual recognition, a visual recognition function starts. The goal is to minimize the on state of the high power consumption visual recognition module to save energy. The embodiment is particularly applied to an application scenario where low power consumption is required. The present disclosure will be illustrated in detail with an example of unlocking of a locked electronic device through visual recognition.

Referring to FIG. 2, showing a system which includes an unlocking module. The system comprises a distance sensor 20, a visual recognition module 21, and an unlocking module 22.

The distance sensor 20 is configured to detect an object close to the electronic device. The visual recognition module 21 is configured to compare based on when the distance sensor detects that that object close to the system, if the object is matched with a preset visual recognition mode (human face, gesture, etc.). The unlocking module 22 is configured to unlock the system at the time the visual recognition module compares that the object matches the preset visual recognition mode.

Specifically, when the system is in a locked state, both the visual recognition module 21 and the unlocking module 22 are in an off-state, the distance sensor 20 is in an on-state to detect, in real time, whether an object is close to the system. If not, the visual recognition module 21 and the unlocking module 22 keep closed. In actual application, in order to improve the accuracy of detection, the distance sensor 20 may perform detections more than once, if it is detected that an object falls within a close distance of the system in the plurality of detections, it is determined that the object is close to the system, wherein the detection times may be preset according to actual application situations. The distance sensor 20 may be an infrared distance sensor, an optical distance sensor, or an ultrasonic distance sensor, or the like. A mobile communication terminal is adopted as the system for example. The distance sensor 20 is usually installed around a receiver at the front of the mobile communication terminal, and may be used together with a light sensor, so as to improve the accuracy of detection.

When the distance sensor 20 detects that an object is close to the system, the visual recognition module 21 starts to compare whether the object matches with a preset visual recognition mode. When the visual recognition module 21 detects that the object matches with the preset visual recognition mode, the unlocking module 22 starts and unlocks the system. For example, face identity recognition is adopted as a preset unlocking recognition mode. The visual recognition module 21 calls a shooting apparatus to shoot an object close to the system, constructs a 3D image, and performs a preliminary face recognition; if a valid human face is recognized, identity recognition for the human face continues; and if there is no valid human face, the visual recognition module 21 is shut off, and the distance sensor 20 continues to detect an object within a close distance. During the identity recognition for a human face, if the identity matching the human face is consistent with an unlocking identity preset by the system, the unlocking recognition mode matches successfully, and the system is unlocked; otherwise, it is prompted that unlocking fails or identity recognition is to be re-performed.

It should be noted that the preset unlocking recognition mode is not limited to 3D facial identity recognitions. There may be other unlocking manners. The present solution is particularly applied to some visual recognition modules with algorithms and high power consumption. For example, the preset unlocking recognition may be unlocking and recognizing facial expression such as eye blinking, or the smiling face of a person with a preset identity, or may be unlocking based on a preset action or a preset head movement of a person with a preset identity; the preset unlocking recognition mode may also be gesture recognition unlocking such as unlocking based on a preset gesture motion; and the preset unlocking recognition mode may also be combining facial recognition and gesture recognition.

Further, power consumption may be more effectively reduced or the accuracy of detection may be improved by including a distance sensor alone or combined with other sensors which can be triggered on by the sensor. For example, an acceleration sensor may be included to better judge whether a user has picked up the phone and has tried to unlock the mobile phone. Under a combination mode, the distance sensor starts only when it is absolutely required instead of working in the background all the time, so as to further reduce the power consumption. That is to say, the distance sensor is started when the preset triggering condition is satisfied. The triggering condition may comprise: screen of the system is turned on or the system is picked up.

Specifically, as shown in FIG. 3, the visual recognition system according to the present embodiment further comprises a sensing module 23, configured to sense whether the system is picked up. In the present embodiment, the distance sensor 20 is triggered when sensing that the system is picked up. The sensing module 23 may be one of an acceleration sensor, a gravity sensor and a gyroscope, and data of the acceleration sensor, the gravity sensor or the gyroscope is adopted or combined to determine whether the system is picked up.

In an application example, the system is in a locked state. When the sensing module 23 senses that the system is picked up, the distance sensor 20 is started; when the distance sensor 20 detects that an object is close to the system, the visual recognition module 21 is started, and a screen of the system is turned on; and when the visual recognition module 21 detects that the object is matched with a preset unlocking recognition mode, the unlocking module 22 is started.

In another application example, the system is in a locked state. When the sensing module 23 senses that the system is picked up, a screen of the system is turned on, and starting of the distance sensor 20 is triggered; when the distance sensor 20 detects that an object is close to the system, the visual recognition module 21 starts; and when the visual recognition module 21 compares that the object matches with a preset unlocking recognition mode, the unlocking module 22 starts.

In other embodiments, a sensing module may not be required, and the distance sensor 20 is triggered on in other manners, for example, by turning on a screen of the system. In this mode, a power button of the system is pressed down, the screen will be turned on, and then the distance sensor 20 starts.

In The foregoing visual recognition system further provides a visual recognition method, including: detecting, by using a distance sensor, an object close to the system; and deciding, whether the object matches a preset visual recognition mode. The distance sensor can be an optical distance sensor like an infrared sensor, or an ultrasonic distance sensor.

Further, when the system is in a locked state, the visual recognition mode comprises an unlocking recognition mode, the visual recognition method further comprises: unlocking the system, when it is compared that the object matches with the preset visual recognition mode. The unlocking recognition mode includes facial recognition unlocking and/or gesture recognition unlocking.

Further, when a triggering condition is satisfied, the distance sensor starts, the triggering condition includes: a screen of the system is turned on or the system is picked up. A sensing module may be used to sense whether the system is picked up. The sensing module comprises at least one of an acceleration sensor, a gravity sensor, and a gyroscope. The screen of the system may be turned on when it is sensed that the system is picked up, or, the screen of the system is turned on when a power button of the system is pressed down.

The present disclosure has the following benefits:

Energy saving—a distance sensor with low power consumption is used to detect an object within an appropriate distance, and when it is compared that an object is close to the system, a visual recognition function starts. Thus, identity recognition, action recognition, or system unlocking, etc. can be performed without turning on a visual recognition module with high power consumption all the time.

Further, other triggering manners are adopted on the basis of the distance sensor or the distance sensor is combined with other sensors. The distance sensor starts by means of triggering manners provided by other sensors, so that the power consumption is more effectively reduced, and the detection accuracy is improved.

Therefore, according to the present disclosure, by using the distance sensor with low power consumption in conjunction with existing visual recognitions, the battery running life of the system can be prolonged without affecting functions such as unlocking and identity recognition of the visual recognition system.

The foregoing visual recognition system and method may be applied to various electronic devices or systems, particularly to a portable electronic device such as a mobile terminal, a tablet computer, or an electronic book. Those skilled in the art may understand that the technical solution of the present disclosure is also applied to other electronic devices with display screens, such as a laptop computer, a desktop computer, or a liquid crystal television, or the like.

Although the present disclosure has been disclosed as above in a preferred implementation manner, it is not used to limit the present disclosure. Any person skilled in the art may make possible variations and modifications on the technical solution of the present disclosure by using the above-disclosed method and technical content without departing from the spirit and scope of the present disclosure. Therefore, any simple modifications, equivalent variations and modifications made on the above implementation manner according to the technical essence of the present disclosure without departing from the content of the technical solution of the present disclosure fall within the scope of protection of the technical solution of the present disclosure.

What is claimed is:

1. A visual recognition system, comprising:
a distance sensor, configured to detect an object close to the system; and
a visual recognition module, configured to compare if the object matches a preset visual recognition mode.

2. The visual recognition system according to claim 1, wherein the visual recognition mode comprises an unlocking recognition mode to unlock the system from a locked state, when the visual recognition module compares that the object matches the preset visual recognition mode.

3. The visual recognition system according to claim 1, wherein when a triggering condition is satisfied, the distance sensor starts, wherein the triggering condition comprises turning on a screen of the system or picking up the system.

4. The visual recognition system according to claim 3, wherein when the system is picked up, the screen of the system is turned on; or, when a power button of the system is pressed down, the screen of the system is turned on.

5. The visual recognition system according to claim 3, further comprising: a sensing module, configured to sense whether the system is picked up.

6. The visual recognition system according to claim 5, wherein the sensing module comprises at least one of an acceleration sensor, a gravity sensor, and a gyroscope.

7. The visual recognition system according to claim 2, wherein the unlocking recognition mode comprises facial recognition unlocking and/or gesture recognition unlocking.

8. The visual recognition system according to claim 1, wherein the distance sensor is an infrared sensor, an optical visible light sensor, or an ultrasonic distance sensor.

9. An electronic device comprising the visual recognition system of claim 1.

10. The electronic device according to claim 9, wherein the electronic device is a mobile terminal, a tablet computer, or an electronic book.

11. A visual recognition method, comprising:
detecting, by using a distance sensor, an object close to the electronic device; and
comparing, when the distance sensor detects that the object, whether the object matches with a preset visual recognition mode.

12. The visual recognition method according to claim 11, wherein when the electronic device is in a locked state, the visual recognition mode comprises an unlocking recognition mode; wherein the visual recognition method further comprises: unlocking the electronic device when it is detected that the object matches the preset visual recognition mode.

13. The visual recognition method according to claim 11, wherein when a triggering condition to the distance sensor is satisfied, the distance sensor starts, and wherein the triggering condition comprises turning on a screen of the electronic device or picking up the electronic device.

14. The visual recognition method according to claim 13, wherein the screen is turned on if the electronic device is picked up or a power button of the electronic device is pressed down.

15. The visual recognition method according to claim 13, further comprising: sensing, by using a sensing module, if the electronic device is picked up.

16. The visual recognition method according to claim 15, wherein the sensing module comprises at least one of an acceleration sensor, a gravity sensor and a gyroscope.

17. The visual recognition method according to claim 12, wherein the unlocking recognition mode comprises facial recognition unlocking and/or gesture recognition unlocking.

18. The visual recognition method according to claim 11, wherein the distance sensor is an infrared sensor, a visible light optical sensor, or an ultrasonic sensor.
